(19) United States
(12) Patent Application Publication
(10) Pub. No.: US 2007/0195703 A1
(43) Pub. Date: Aug. 23, 2007

(54) System and method for monitoring a site using time gap analysis

(75) Inventors: George Boyajian, New York, NY (US); David Stern, Brooklyn, NY (US); Bill Seitz, New York, NY (US)

Correspondence Address: COOPER & DUNHAM, LLP, 1185 AVENUE OF THE AMERICAS, NEW YORK, NY, 10036, US

(73) Assignee: Living Independently Group Inc., New York, NY (US)

(21) Appl. No.: 11/359,662

(22) Filed: Feb. 22, 2006

(51) Int. Cl. H04L 12/26

(52) U.S. Cl. 370/241

(57) ABSTRACT

A method for monitoring a site includes calculating a learned threshold time based on a statistical analysis of lengths of time between sensor firings of one or more sensors. A first sensor firing is detected from the one or more sensors. The length of time that has elapsed since the first sensor firing is measured. The length of time that has elapsed since the first sensor firing is compared with the learned threshold time. An alarm condition is generated when the length of time that has elapsed since the first sensor firing exceeds the learned threshold time and no second sensor firing has been detected since the first sensor firing.

### BACKGROUND

1. Technical Field

The present disclosure relates to monitoring a site, and, more specifically, to a system and method for monitoring a site using time gap analysis.

2. Description ot the Related Art

Monitoring a site, for example a geographically limited area, an area bound by walls, such as an apartment, a single family home, a room, multiple rooms, a warehouse, a fenced in field, an aircraft taxiway, factory floor, a school or a public place usually involves measuring activity, either visually, photographically, or through the use of sensors. Through the use of sensors, a variety of activities can be monitored remotely, such as doors opening, lights turning on, the presence of smoke or fire, etc.

In a home, for example, sensors can be used to monitor the activities of persons living alone, such as the elderly. As the elderly population continues to grow, available healthcare resources are spread increasingly thin. As a result, helping to ensure the safety and independence of the elderly becomes increasingly important.

Accidents in the home pose a great risk to the health, vitality and independence of the elderly. Accidents such as falls are common and can be catastrophic resulting in major injury, substantial loss of independence and even death. When an elderly person suffers such a fall, swift medical attention is of the utmost importance. The first few hours after a fall can be pivotal. If help can be rendered within this time, the patient's chances for recovery can be greatly enhanced.

Similarly, accidents and/or emergencies in various public and private places may benefit from monitoring. For example, places of business and commerce such as offices, stores and factories may be monitored so that attention, including fire, flood or medical attention, may be summoned if need be.

Unfortunately, present systems often take a very long time before a problem is discovered or help summoned. One approach to monitoring is to provide a home health aide to monitor persons living alone, or a foreperson to monitor a factory floor. However this approach can be costly and may compromise the sense of privacy and independence of the individuals being monitored. Moreover, such personal assistance and/or monitoring is generally only for a limited period of time each day thereby providing no safeguards for the hours when human monitors are not present.

Prior art technological solutions are available for monitoring the home or other sites. These prior art devices fall into two categories: (1) user-worn sensors; and (2) non-worn sensors. User-worn systems equip the user with a radio transmitter so that medical assistance or other emergency assistance can be summoned by the user when needed. This system suffers from the disadvantages that the user must wear the radio transmitter, and the user must not have been rendered unconscious or otherwise unable to activate the radio transmitter by the accident or medical condition that caused the emergency. In another system, a person wears an accelerometer that detects a rapid fall. However, slow falls (slumping) may not be detected.

Other systems, such as the system described in U.S. Pat. No. 4,259,548 to Fahey et al., utilize multiple sensors located within the home of the monitored person for monitoring the activities of daily living (or ADLs) of the monitored person. When ADLs are detected during the course of a day, the system interprets this as an “all is well”situation. The failure for the monitored person to perform an ADL within a preset or prescribed time since the last ADL is interpreted by the system as an alarm condition and an alarm sequence is initiated and appropriate action is taken.

However, systems such as Fahey et al. employ a preset time that is allowed to elapse after an event is detected but prior to initiating the alarm sequence. This time is preprogrammed and remains constant. Moreover, the only guidance provided by Fahey et al. on how to determine the preset period of time is that this period should be shorter between bathroom activities than between other activities. Often, systems such as Fahey et al. send false alarms, for example, for prolonged naps or other limited periods of inactivity, causing users to disable the inactivity alarm or set the length of inactivity so great as to render the inactivity monitor meaningless.

Therefore, accurately determining an effective period of inactivity is of the highest priority in the home, workplace, prisons, schools, and a variety of other institutions and locations. Setting the predetermined period too long can result in the monitored person having to wait many hours after an emergency before help is summoned. Setting the predetermined period of time too short can result in frequent false alarms that may drain emergency response resources, potentially resulting in user frustration that may lead to the user deactivating the system thereby leaving the user unprotected.

There is therefore a need to implement a method and system for effectively arriving at a period of inactivity that can be used to help determine when assistance should be summoned to a particular, monitored locale.

### SUMMARY

A method for monitoring a site includes calculating a learned threshold time based on a statistical analysis of lengths of time between sensor firings of one or more sensors. A first sensor firing is detected from the one or more sensors. The length of time that has elapsed since the first sensor firing is measured. The length of time that has elapsed since the first sensor firing is compared with the learned threshold time. An alarm condition is generated when the length of time that has elapsed since the first sensor firing exceeds the learned threshold time and no second sensor firing has been detected since the first sensor firing.

A system for monitoring a site includes one or more sensors installed within the monitored site for sensing activity and firing when activity is sensed. A data processing unit calculates a learned threshold time based on a statistical analysis of lengths of time between sensor firings of one or more sensors. A first sensor firing is detected from the one or more sensors. The length of time that has elapsed since the first sensor firing is measured. The length of time that has elapsed since the first sensor firing is compared with the learned threshold time. An alanm condition is generated when the length of time that has elapsed since the first sensor firing exceeds the learned threshold time and no second sensor firing has been detected since the first sensor firing.

A computer system includes a processor and a program storage device readable by the computer system, embodying a program of instructions executable by the processor to perform method steps for monitoring a site. The method includes calculating a learned threshold time based on a statistical analysis of lengths of time between sensor firings of one or more sensors. A first sensor firing is detected from the one or more sensors. The length of time that has elapsed since the first sensor firing is measured. The length of time that has elapsed since the first sensor firing is compared with the learned threshold time. An alarm condition is generated when the length of time that has elapsed since the first sensor firing exceeds the learned threshold time and no second sensor firing has been detected since the first sensor firing.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows a monitoring system according to an embodiment of the present invention;

FIG. 2 shows a graph of the frequency of time gaps, or inactivity, with the threshold time gap according to an embodiment of the present invention; and

FIG. 3 shows an example of a computer system capable of implementing the method and apparatus according to embodiments of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Embodiments of the present invention may utilize an array of sensors positioned at various locations within the monitored site. For example, a set of five sensors may be used. Embodiments of the present invention may alternatively use a single sensor. The monitored site may be, for example, the home of the person being monitored, a factory, a school yard, a prison cell or practically any site. The sensors may be, for example, motion detectors, sound detectors, sensors that fire upon the opening or closing of a door or cabinet, sensors that detect the use of electronic equipment or an appliance, or any other form of detector that is designed to detect any type of activity. For example, the sensors may be conventional infrared motion detectors. The sensors may be positioned, for example, at various “choke points” within the monitored site. Choke points are the areas within the site that are most heavily trafficked. For example, sensors may be placed outside of bathrooms, in high traffic hallways, within the kitchen and/or in the living room. Alternatively, sensors might be placed in areas where people spend the most time conducting their activities. Placement may be determined, for example, based on the where the targeted behavior to be measured most often takes place.

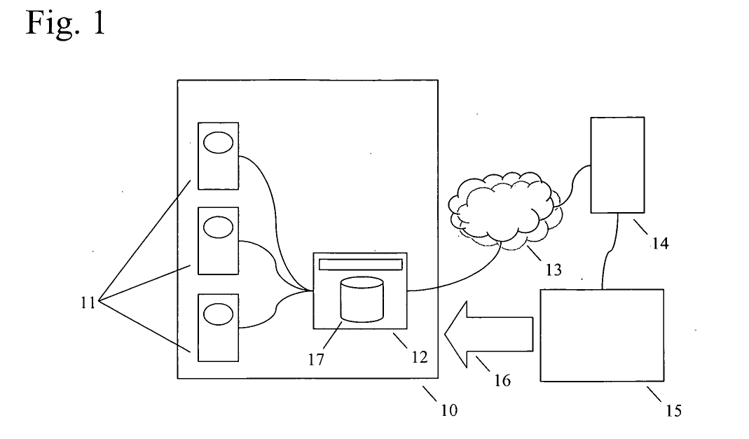

FIG. 1 shows one embodiment of the monitoring system described and claimed herein. Each sensor 11 within the monitored site 10 may be in communication with a local base station device 12, which may be in communication with a remote command location 14 over a communications network 13. Alternatively, each sensor 11 may be in direct communication with the remote command location 14. The remote command location may be any remote location, including but not limited to the home or office of a responsible family member, a privately operated service center, an emergency medical response dispatch facility, a foreperson's office, a principal's office, or a warden's office, for example.

According to one embodiment of the present invention, each sensor 11 is in communication with a local base station device 12 and the base station device 12 is in communication with a service center 14. The sensors 11 may be connected to the base station 12 by copper wire discretely run throughout the site. Alternatively, or additionally, the sensors 11 may communicate with the base station 12 by radio or other signals. The base station 12 may be able to communicate with the service center 14 over a communications network 13 such as a local area network or a wide area network, including the public telephone system or the Internet.

Each sensor 11 may monitor for evidence of activity, which can be any type of motion or change in status of the monitored site 10. When activity is sensed, the sensor may store a record of the activity (event data) locally and/or communicate the event data to the base station 12 and/or service center 14. The activity of any or all sensors 11 within the monitored site 10 may be sent to the base station 12 or to a remote service center 14. According to one preferred embodiment, all activity is collected at the base station 12.

The event data may be analyzed, for example, in real-time, to determine the length of time that separates a given event detected by any sensor 11 from the next event detected by any sensor 11. This length of time between sensor events is known as the time gap. A data processing unit, for example, at either the base station 12 or remote service center 14, may save all time gaps to a database residing within base station, for example, a hard disk and/or nonvolatile memory 17, or transmit this information to a local area and/or wide area network for storage or computation at another remote location. Alternatively, the data processing unit may be within the sensor itself. In any embodiment of the present invention, the miniaturization of computing and electronic components may permit all of the component activities to be completed at a variety of levels, from the level of the individual sensor, among sensors, at a “base station” on site, remotely or via some combination of the above.

This stored, time gap data may be periodically or continuously subject to statistical analysis. For example statistical parameters may be calculated such as the number of observed time gaps (N) in a given period of time (such as nighttime hours, morning/waking hours, the afternoon, dinner hours, and evening) the mean (μ) and the standard deviation (σ). These calculated parameters may also be stored in the database and updated periodically or upon command.

A learned threshold time may be periodically or continuously calculated based on one or more of these calculated parameters, which reflects the patterns or lengths of inactivitv at the monitored site 10. For example, the learned threshold time (Δ_{T}) wmay be calculated from the length of time that passes after a sensor fires after which there is no activity, causing an alarm condition. The base station 12 may be responsible for monitoring the length of time elapsed since the last observed data event (Δ) or activity. When the base station 12 determines that the length of time that has elapsed since the last observed sensor firing or data event exceeds the learned threshold time (Δ>Δ_{T}), then the base station may initiate the alarm condition and, for example, contact the service center 14 or an individual to indicate that an alarm condition has occurred. The service center 14 may also contact the appropriate emergency medical response dispatcher 15, or others who may dispatch an ambulance 16 or other assistance to the monitored site, for example, after providing the monitored person an opportunity to respond to deactivate the alarm condition. The service center 14, or for example, the base station 12, may alternatively or additionally contact a family member or care giver to inform them of the alarm condition.

As described above, the learned threshold time (Δ_{T}) is a length of time that is exceeded after a sensor fires, causing an alarm condition. Embodiments of the present invention may detect a first sensor firing from any of the sensors. When the first sensor firing is detected, a timer/counter may be started. The timer may continue timing until the next time any of the sensors fires. If the timer is stopped as a result of a next sensor firing, the next sensor firing may become a “first sensor firing,” resetting the timer until a new “next sensor firing” is detected. If at any point, the timer exceeds the learned threshold time, the alarm condition occurs.

It should be noted that the “first sensor firing” is to be understood as a firing of any of the sensors, not necessarily the firing of a “first sensor” and without regard to whether that sensor has previously fired. The “next sensor firing” is to be understood as a subsequent firing of any of the sensors, not necessarily the subsequent firing of the same sensor that fired during the first sensor firing. Therefore, the “next sensor firing” may be a second firing of the sensor that was responsible for the “first sensor firing” or it may be a firing of any of the other sensors in the array of sensors installed at the site.

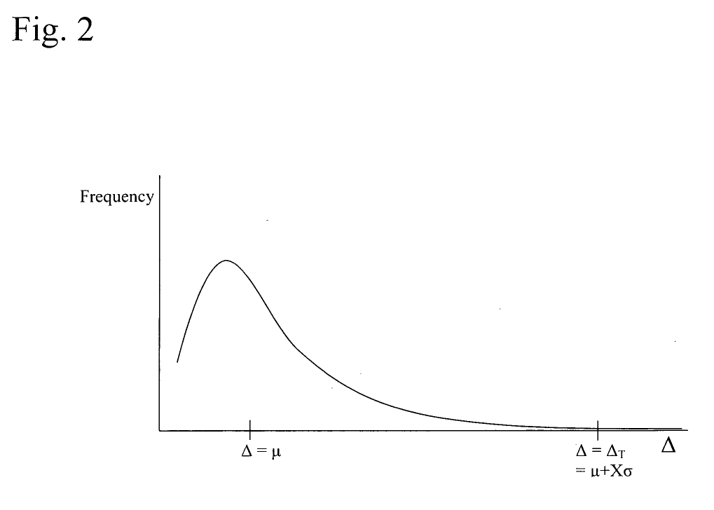

The learned threshold time may be calculated based on a number of different methods, based on the collected data reflecting periods of inactivity at the site. For example, the method and system may employ tools developed in the statistical analysis, series analysis and/or trend analysis fields that are well known in art. FIG. 2 shows a graph of the frequency of time gaps, i.e. the number of times a particular time gap (Δ) or period of inactivity has been observed, with the learned threshold time (Δ_{T}) calculated according to an embodiment of the present invention. For example, according to the Empirical Rule of Statistics, approximately 100% of all observed data points should fall within the range of plus or minus 3 standard deviations from the mean (range=(μ−3σ, μ+3σ)). Therefore, by way of example, the learned threshold time (Δ_{T}) may be set as the mean time gap plus three times the time gap standard deviation (Δ_{T}μ+3σ).

Alternatively, the learned threshold time may be calculated based on a predetermined multiple of the calculated standard deviation. For example, Δ_{T}=μ+Xσ, where X is the predetermined multiple. For example, the predetermined multiple X may equal 2.

Data collected by the method and system described herein may have a variety of distributions, for example, data distributions may be exponential, normal, etc. Data may be analyzed relative to the inherent properties of the statistical distribution for which it correlates, for example. This can be done, for example, parametrically through standard statistical analysis tools known in the art with the appropriate transformations for skewed data, and/or can be conducted through rarefaction, or other sampling techniques. In short, any method of statistical analysis may be used to identify the length of time that will cause an alarm condition and thereby capture the targeted behavior (or lack thereof), while reducing the false positive rate to an acceptable level.

Time gap analysis is defined herein as the performance of statistical analysis on the length of time elapsed since the last sensed or observed event. This length of time may also be referred to as the time gap (Δ).

As can be seen from the graph of FIG. 2, the mean time gap (Δ=μm ) may occur around the location of the most frequently occurring time gap. As the observed time gaps become longer, the frequency by which the time gaps are observed may fall off steeply. For example, the learned threshold time may be located at a point in the curve where the frequency has fallen off sharply so that ordinary time gaps do not trigger the alarm condition. A time gap sufficient to trigger an alarm condition may appear as an outlier on the curve.

Embodiments of the present invention may utilize other statistical approaches, series analysis and/or trend analysis to calculating the learned threshold time based on prior observed time gaps. These methods are know to those of ordinary skill in the art.

The learned threshold time may be periodically or continuously recalculated as new time gap or inactivity data is received. For example, the learned threshold time may be recalculated for every new time gap, or every period of inactivity, at the site, by the base station (i.e. every time a data event is observed) or at some other location. Alternatively, the threshold time gap may be recalculated periodically, for example, once a week, or upon a local or remote command.

When statistically calculating the learned threshold time, every recorded time gap may be used. Alternatively, a set of the most recently recorded time gaps may be used to determine the learned threshold time, for example, the previous 100 time gaps or time gaps occurring over the past 7 days. By using only recent data to calculate the learned threshold time, embodiments of the present invention may be more responsive to the current behavior trends of the monitored site.

When embodiments of the present invention are first activated, a default threshold time (Δ₀) may be used until enough time gaps have been recorded to calculate a statistically significant learned threshold time. For example, until a period of seven days or a number of days that cover normal activities that are periodic in nature. The default threshold time may be predetermined, for example, based on a statistical analysis of time gaps calculated based on other users of the invention. In such an embodiment, the default threshold time may be factory set, or sent to the base station from the service center, or sent from a remote location.

Because the learned threshold time is calculated based on observed time gaps or periods of inactivity, embodiments of the present invention may seek to disregard certain observed time gaps that are not indicative of the monitored person or site's normal behavior patterns to prevent these data points from skewing the threshold time gap calculations. For example, when the monitored person is known to be absent from the monitored site, for example, the person inhabiting the monitored site is away from home, time gap data may be disregarded. For example, outside door sensors for sensing when the monitored person has left the monitored site may be used to disable any collection or analysis of time gap information. The counting and comparing of the time gaps may be temporarily suspended for reasons of expected inactivity even when the site remains occupied. Alternatively, periods of time might be excluded when activity is expected to be low, for example, at night when people are sleeping or a factory is idle.

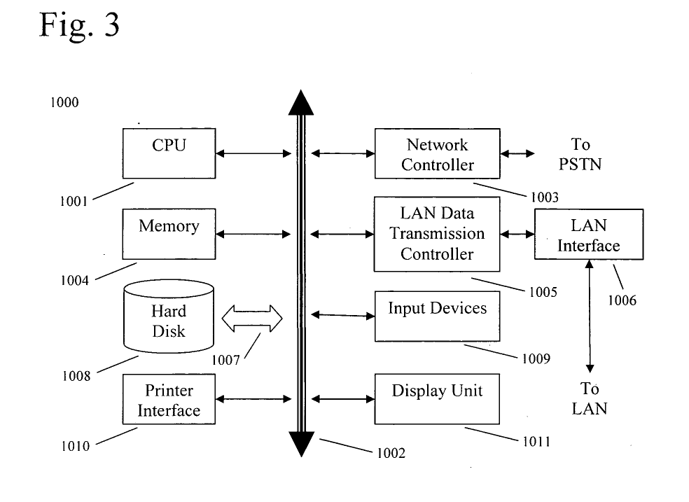

FIG. 3 shows an example of a computer system which may implement the system and method of the present disclosure. For example, the system and method of the present disclosure may be implemented in the form of a software application running on a computer system, for example, a mainframe, personal computer (PC), handheld computer, server, microprocessor or microcontroller, etc. The software application may be stored on a recording media locally accessible by the computer system and accessible via a hard wired or wireless connection to a network, for example, a local or wide area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

One or more steps of the embodiments of the present invention may be performed in a location and time that is remote with respect to the monitored site at the time of monitoring.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A method for monitoring a site, comprising the steps of:
calculating a learned threshold time based on a statistical analysis of lengths of time between sensor firings of one or more sensors;
detecting a first sensor firing from the one or more sensors;
measuring the length of time that has elapsed since the first sensor firing;
comparing the length of time that has elapsed since the first sensor firing with the learned threshold time; and
generating an alarm condition when the length of time that has elapsed since the first sensor firing exceeds the learned threshold time and no second sensor firing has been detected since the first sensor firing.

2. The method of claim 1, wherein when the second sensor fires before the learned threshold time has elapsed, the steps of detecting, measuring, comparing and generating are repeated.

3. The method of claim 2, wherein the learned threshold time is updated based on statistical analysis of lengths of time between the subsequent sensor firings.

4. The method of claim 1, additionally comprising the step of alerting one or more caregivers or responsible persons of the alarm condition when an alarm condition has been generated.

5. The method of claim 1, additionally comprising the step of summoning an emergency response to the monitored site when an alarm condition has been generated, the emergency response including medical assistance when appropriate.

6. The method of claim 1, wherein the learned threshold time is calculated based on trend analysis of lengths of time between previously observed sensor firings.

7. The method of claim 1, wherein the learned threshold time is based on the site monitored or from one or more other monitored sites.

8. The method of claim 1, wherein the learned threshold time is calculated based on statistical analysis of lengths of time between previously observed sensor firings comprising the steps of:
recording a set of time gaps equaling the lengths of time between previously observed sensor firings;
calculating an average for the set of time gaps;
calculating a standard deviation for the set of time gaps;
setting the learned threshold time as the average time plus a multiple of the standard deviation.

9. The method of claim 8, wherein said multiple is 2 times the standard deviation.

10. The method of claim 8, wherein said multiple is 3 times the standard deviation.

11. The method of claim 1, wherein the learned threshold time is set to a default threshold time when the number of previously observed sensor firings is zero or an insufficient number to calculate a statistically significant threshold time.

12. The method of claim 11, wherein the number of previously observed sensor firings sufficient to calculate a statistically significant threshold time is set as the number of previously observed sensor firings observed over a period of seven days or a number of days that cover normal activities that are periodic in nature.

13. The method of claim 1, wherein the steps of detecting, measuring and comparing time gaps are temporarily suspended and resumed.

14. A system for monitoring a site, comprising:
one or more sensors installed within the monitored site for sensing activity and firing when activity is sensed; and
a data processing unit for:
calculating a learned threshold time based on a statistical analysis of lengths of time between sensor-firings of one or more sensors;
detecting a first sensor firing from the one or more sensors;
measuring the length of time that has elapsed since the first sensor firing;
comparing the length of time that has elapsed since the first sensor firing with the learned threshold time; and
generating an alarm condition when the length of time that has elapsed since the first sensor firing exceeds the learned threshold time and no second sensor firing has been detected since the first sensor firing.

15. The system of claim 14, wherein the one or more sensors are motion detectors.

16. The system of claim 14, wherein the data processing unit is a base station in communication with the one or more sensors installed within the monitored site.

17. The system of claim 16, wherein the base station is in communication with a service center and an alarm condition generated by the base station is communicated to the service center.

18. The system of claim 14, wherein the data processing unit is located at a service center and is in communication with the one or more sensors installed within the monitored site.

19. The system of clain 14, wherein one or more caregivers is alerted of the alarm condition when an alarm condition has been generated.

20. The system of claim 14, wherein an emergency response is summoned to the monitored site when an alarm condition has been generated, the emergency response including medical assistance when appropriate

21. The system of claim 14, wherein the learned threshold time is calculated based on trend analysis of lengths of time between previously observed sensor firing signals.

22. The system of claim 14, wherein the learned threshold time is calculated based on statistical analysis of lengths of time between previously observed sensor firing signals, comprising the steps of:
recording a set of time gaps equaling the lengths of time between previously observed sensor firing signals;
calculating an average for the set of time gaps;
calculating a standard deviation for the set of time gaps; and
setting the learned threshold time as the average time plus a multiple of the standard deviation.

23. The system of claim 22, wherein said multiple is 2 times the standard deviation.

24. The system of claim 22, wherein said multiple is 3 times the standard deviation.

25. The system of claim 14, wherein the learned threshold time is set to a default threshold time when the number of previously observed sensor firing signals is zero or insufficient to calculate a statistically significant threshold time.

26. The system of claim 25, wherein the number of previously observed sensor firing signals sufficient to calculate a statistically significant learned threshold time is set as the number of previously observed sensor firing signals observed over a period of seven days.

27. The system of claim 14, wherein the data processing unit temporarily suspends the detecting, measuring and comparing and resumed.

28. A computer system comprising:
a processor; and
a program storage device readable by the computer system, embodying a program of instructions executable by the processor to perform method steps for monitoring a site, the method comprising:
calculating a learned threshold time based on a statistical analysis of lengths of time between sensor firings of one or more sensors;
detecting a first sensor firing from the one or more sensors;
measuring the length of time that has elapsed since the first sensor firing;
comparing the length of time that has elapsed since the first sensor firing with the learned threshold time; and
generating an alarm condition when the length of time that has elapsed since the first sensor firing exceeds the learned threshold time and no second sensor firing has been detected since the first sensor firing.

29. The computer system of claim 28, wherein when the second sensor fires before the learned threshold time has elapsed, the steps of detecting, measuring, comparing and generating are repeated.

30. The computer system of claim 29, wherein the learned threshold time is updated based on statistical analysis of lengths of time between the subsequent sensor firings.

31. The computer system of claim 28, additionally comprising the step of alerting one or more caregivers or responsible persons of the alarmi condition when an alarm condition has been generated.

32. The computer system of claim 28, additionally comprising the step of summoning an emergency response to the monitored site when an alarm condition has been generated, the emergency response including medical assistance when appropriate

33. The computer system of claim 28, wherein the learned threshold time is calculated based on trend analysis of lengths of time between previously observed sensor firings.

34. The computer system of claim 28, wherein the learned threshold time is based on the site monitored or from one or more other monitored sites.

35. The computer system of claim 28, wherein the learned threshold time is calculated based on statistical analysis of lengths of time between previously observed sensor firings comprising the steps of:
recording a set of time gaps equaling the lengths of time between previously observed sensor firings;
calculating an average for the set of time gaps;
calculating a standard deviation for the set of time gaps;
setting the learned threshold time as the average time plus a multiple of the standard deviation.

36. The computer system of claim 35, wherein said multiple is 2 times the standard deviation.

37. The computer system of claim 35, wherein said multiple is 3 times the standard deviation.

38. The computer system of claim 28, wherein the learned threshold time is set to a default threshold time when the number of previously observed sensor firings is zero or an insufficient number to calculate a statistically significant threshold time.

39. The computer system of claim 38, wherein the number of previously observed sensor firings sufficient to calculate a statistically significant threshold time is set as the number of previously observed sensor firings observed over a period of seven days or a number of days that cover normal activities that are periodic in nature.

40. The computer system of claim 28, wherein the steps of detecting, measuring and comparing time gaps are temporarily suspended and resumed.
